(19) United States
(12) Patent Application Publication
(10) Pub. No.: US 2026/0080586 A1
(43) Pub. Date: Mar. 19, 2026

(54) GENERATION DEVICE, AND GENERATION METHOD

(71) Applicant: Mitsubishi Electric Corporation, Tokyo (JP)

(72) Inventor: Kei SUZUKI, Tokyo (JP)

(73) Assignee: Mitsubishi Electric Corporation, Tokyo (JP)

(21) Appl. No.: 19/395,910

(22) Filed: Nov. 20, 2025

Related U.S. Application Data
(63) Continuation of application No. PCT/JP2023/023266, filed on Jun. 23, 2023.

(51) Int. Cl. G06T 11/20

(52) U.S. Cl. CPC G06T 11/26

(57) ABSTRACT

A generation device includes a generation unit that generates a graph in which a plurality of node groups corresponding to a plurality of component groups arranged in parallel are connected in series or a graph in which a first node corresponding to a first component belonging to a first component group among the plurality of component groups and a second node corresponding to a second component belonging to a second component group among the plurality of component groups are connected to each other via an edge.

### CROSS-REFERENCE TO RELATED APPLICATION

This application is a continuation application of International Application No. PCT/JP2023/023266 having an international filing date of Jun. 23, 2023.

### BACKGROUND OF THE INVENTION

### 1. Field of the Invention

The present disclosure relates to a generation device, and a generation method.

### 2. Description of the Related Art

A robot is formed with a plurality of components. There are cases where the configuration of a robot is represented by a graph. A node included in the graph represents a component. Connective relationship between components is represented by an edge. For example, such a graph is described in Non-patent Reference 1. Further, reinforcement learning is described in the Non-patent Reference 1. An agent is capable of executing the reinforcement learning by using the graph.

Non-patent Reference 1: Wenlong Huang et al., “One Policy to Control Them All: Shared Modular Policies for Agent-Agnostic Control”, ICML, 2020

A message is transmitted in the graph. The message can be a message for making a plurality of components perform the same movement or similar movements (hereinafter referred to as an “equivalence message”), a message for making each component perform an independent movement (hereinafter referred to as an “independence message”), a message for making a plurality of components perform coordinated movements (hereinafter referred to as a “cooperation message”), or the like.

Incidentally, the graph is generated in a form represented by the hardware configuration of the robot. For example, when a plurality of components is arranged in parallel, a plurality of nodes included in the graph is arranged in parallel. Since the plurality of nodes is arranged in parallel, the equivalence message is transmitted to the plurality of nodes. However, since the plurality of nodes is arranged in parallel, the agent is incapable of learning movements indicated by messages other than equivalence messages.

### SUMMARY OF THE INVENTION

An object of the present disclosure is to generate a graph for making the agent learn movements indicated by messages other than equivalence messages.

A generation device according to an aspect of the present disclosure is provided. The generation device includes a generation unit that generates a graph in which a plurality of node groups corresponding to a plurality of component groups arranged in parallel are connected in series or a graph in which a first node corresponding to a first component belonging to a first component group among the plurality of component groups and a second node corresponding to a second component belonging to a second component group among the plurality of component groups are connected to each other via an edge.

According to the present disclosure, a graph for making the agent learn movements indicated by messages other than equivalence messages can be generated.

### BRIEF DESCRIPTION OF THE DRAWINGS

The present disclosure will become more fully understood from the detailed description given hereinbelow and the accompanying drawings which are given by way of illustration only, and thus are not limitative of the present disclosure, and wherein:

FIG. 1 is a diagram showing hardware included in a generation device;

FIG. 2 is a block diagram showing functions of the generation device;

FIG. 3 is a diagram showing a comparative example of a graph;

FIG. 4 is a diagram showing a concrete example (No. 1) of a graph generation process;

FIG. 5 is a diagram showing a concrete example (No. 2) of the graph generation process;

FIG. 6 is a diagram showing a concrete example of the graph generation process in a first modification;

FIG. 7 is a diagram showing a concrete example of the graph generation process in a second modification; and

FIG. 8 is a diagram showing a concrete example of the graph generation process in a third modification.

### DETAILED DESCRIPTION OF THE INVENTION

An embodiment will be described below with reference to the drawings. The following embodiment is just an example and a variety of modifications are possible within the scope of the present disclosure.

### Embodiment

FIG. 1 is a diagram showing hardware included in a generation device. The generation device 100 is a computer. The generation device 100 is a device that executes a generation method.

The generation device 100 generates a graph included in an agent. The graph is formed with a plurality of nodes and a plurality of edges. The agent executes reinforcement learning by using the generated graph.

The generation device 100 includes a processor 101, a volatile storage device 102 and a nonvolatile storage device 103.

The processor 101 controls the whole of the generation device 100. The processor 101 is a Central Processing Unit (CPU), a Field Programmable Gate Array (FPGA) or the like, for example. The processor 101 can also be a multiprocessor. Further, the generation device 100 may include processing circuitry.

The volatile storage device 102 is main storage of the generation device 100. The volatile storage device 102 is a Random Access Memory (RAM), for example. The nonvolatile storage device 103 is auxiliary storage of the generation device 100. The nonvolatile storage device 103 is a Hard Disk Drive (HDD) or a Solid State Drive (SSD), for example.

Next, functions included in the generation device 100 will be described below.

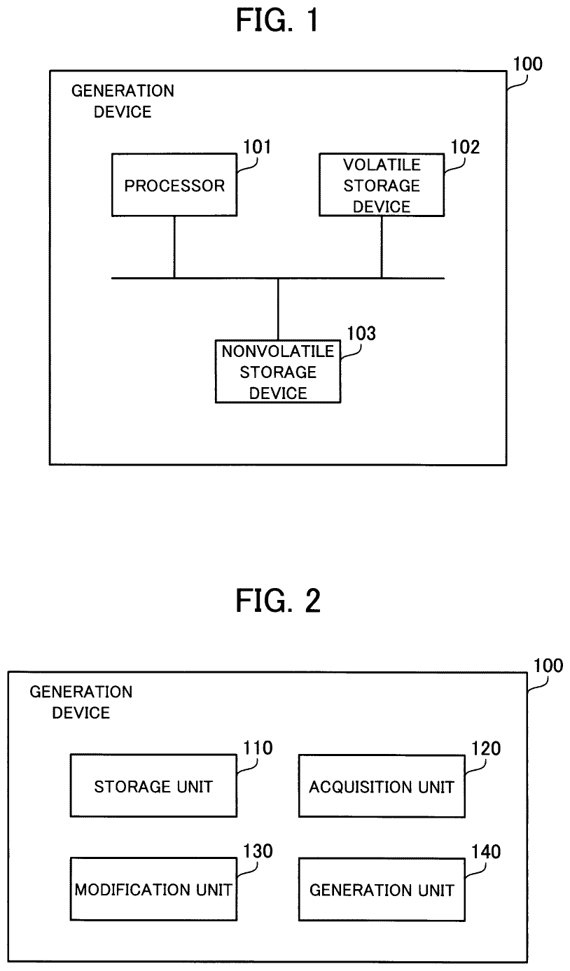

FIG. 2 is a block diagram showing the functions of the generation device. The generation device 100 includes a storage unit 110, an acquisition unit 120, a modification unit 130 and a generation unit 140.

The storage unit 110 may be implemented as a storage area reserved in the volatile storage device 102 or the nonvolatile storage device 103.

Part or all of the acquisition unit 120, the modification unit 130 and the generation unit 140 may be implemented by processing circuitry. Further, part or all of the acquisition unit 120, the modification unit 130 and the generation unit 140 may be implemented as modules of a program executed by the processor 101. For example, the program executed by the processor 101 is referred to also as a generation program. The generation program has been recorded in a record medium, for example.

The storage unit 110 stores a variety of information.

The acquisition unit 120 acquires hardware configuration information regarding a robot. For example, the acquisition unit 120 acquires the hardware configuration information from the storage unit 110. Further, for example, the acquisition unit 120 acquires the hardware configuration information from an external device. Incidentally, the external device is a device existing outside the generation device 100. The external device is a cloud server, for example. Parenthetically, illustration of the external device is left out.

The hardware configuration information indicates that a plurality of component groups is arranged in parallel. This sentence may also be expressed as follows. The hardware configuration information indicates that a plurality of groups is arranged in parallel. Incidentally, each component group or group includes one or more components.

The modification unit 130 identifies the plurality of component groups arranged in parallel based on the hardware configuration information. The modification unit 130 modifies the arrangement of the plurality of identified component groups to a series arrangement.

The generation unit 140 generates a graph based on the modified hardware configuration information.

Next, a graph generation process will be described below by using concrete examples. First, a description will be given of a case where the graph is generated in a form represented by the hardware configuration of the robot.

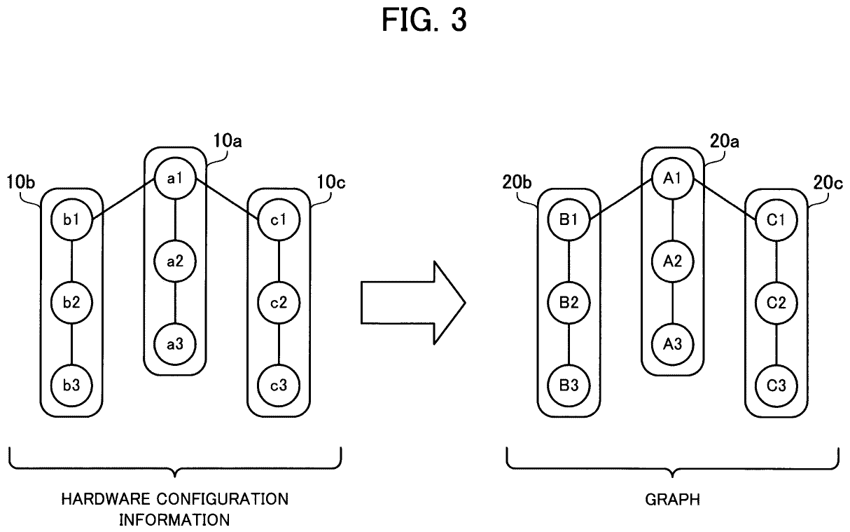

FIG. 3 is a diagram showing a comparative example of the graph. The hardware configuration information indicates that a plurality of component groups is arranged in parallel. The illustration on the left in FIG. 3 shows component groups 10a, 10b and 10c. Each component group includes one or more components. Components a1, a2 and a3 belong to the component group 10a. Components b1, b2 and b3 belong to the component group 10b. Components c1, c2 and c3 belong to the component group 10c.

It is assumed that the graph is generated in a form represented by the hardware configuration. The illustration on the right in FIG. 3 shows the generated graph. The component groups 10a, 10b and 10c correspond to node groups 20a, 20b and 20c. The components a1 to a3 correspond to nodes A1 to A3. The components b1 to b3 correspond to nodes B1 to B3. The components c1 to c3 correspond to nodes C1 to C3.

When a plurality of node groups is arranged in parallel as shown in the illustration on the right in FIG. 3, the agent is incapable of learning movements indicated by messages (e.g., independence messages) other than equivalence messages.

Therefore, the generation device 100 generates the graph as described below.

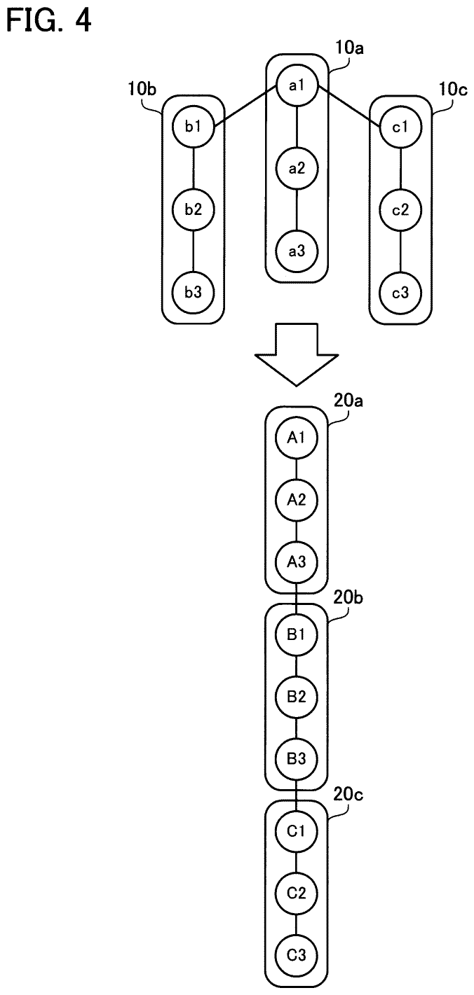

FIG. 4 is a diagram showing a concrete example (No. 1) of the graph generation process. The modification unit 130 identifies the component groups 10a, 10b and 10c arranged in parallel based on the hardware configuration information. The modification unit 130 modifies the arrangement of the component groups 10a, 10b and 10c to a series arrangement.

The generation unit 140 generates a graph based on the modified hardware configuration information. Specifically, the generation unit 140 generates a graph in which the node groups 20a, 20b and 20c corresponding to the component groups 10a, 10b and 10c are connected in series.

Thanks to the series connection of the node groups 20a, 20b and 20c, the agent is capable of learning movements indicated by independence messages.

It is also possible for the generation device 100 to execute the following process. The process will be described below by using a concrete example.

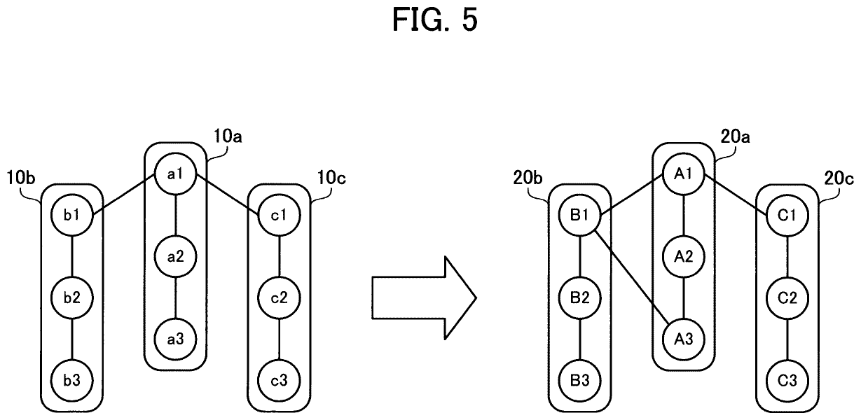

FIG. 5 is a diagram showing a concrete example (No. 2) of the graph generation process. The modification unit 130 identifies the plurality of component groups arranged in parallel based on the hardware configuration information. For example, the modification unit 130 identifies the component groups 10a, 10b and 10c arranged in parallel based on the hardware configuration information. The modification unit 130 modifies the hardware configuration information so that a first component belonging to a first component group among the plurality of identified component groups and a second component belonging to a second component group among the plurality of component groups are electrically connected to each other. For example, the modification unit 130 modifies the hardware configuration information so that the component a3 belonging to the component group 10a among the component groups 10a, 10b and 10c and the component b1 belonging to the component group 10b among the component groups 10a, 10b and 10c are electrically connected to each other.

The generation unit 140 generates a graph based on the modified hardware configuration information. Specifically, the generation unit 140 generates a graph in which a first node corresponding to the first component belonging to the first component group among the plurality of component groups and a second node corresponding to the second component belonging to the second component group among the plurality of component groups are connected to each other via an edge. For example, the generation unit 140 generates a graph in which the node A3 corresponding to the component a3 belonging to the component group 10a and the node B1 corresponding to the component b1 belonging to the component group 10b are connected to each other via an edge.

The connection of the node A3 and the node B1 enables the transmission of a cooperation message. For example, the cooperation message is transmitted from the node A3 to the node B1. Accordingly, the agent is capable of learning cases where the node A3 and the node B1 coordinate with each other.

As described above, the agent is capable of learning movements indicated by independence messages or cooperation messages by using a graph. Thus, according to this embodiment, the generation device 100 is capable of generating a graph for making the agent learn movements indicated by messages other than equivalence messages.

### First Modification of Embodiment

It is also possible for the generation device 100 to execute the following process. The process will be described below by using a concrete example.

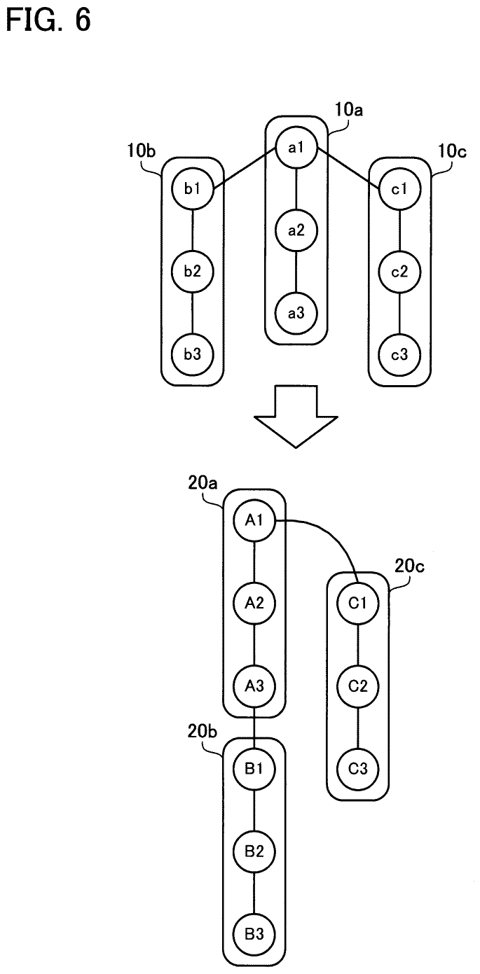

FIG. 6 is a diagram showing a concrete example of the graph generation process in a first modification. The modification unit 130 identifies the plurality of component groups arranged in parallel based on the hardware configuration information. For example, the modification unit 130 identifies the component groups 10a, 10b and 10c arranged in parallel based on the hardware configuration information.

The modification unit 130 modifies two or more component groups among the plurality of identified component groups to a series arrangement. For example, the modification unit 130 modifies the component groups 10a and 10b among the component groups 10a, 10b and 10c to a series arrangement.

The generation unit 140 generates a graph based on the modified hardware configuration information. Specifically, the generation unit 140 generates a graph in which two or more node groups corresponding to the two or more component groups among the plurality of component groups are connected in series. For example, the generation unit 140 generates a graph in which the node groups 20a and 20b corresponding to the component groups 10a and 10b among the component groups 10a, 10b and 10c are connected in series. Further, the remaining component group (e.g., the component group 10c) among the plurality of component groups has not been modified by the modification unit 130. Therefore, the two or more node groups connected in series and the node group corresponding to the remaining component group among the plurality of component groups are connected in parallel. For example, the node groups 20a and 20b and the node group 20c are connected in parallel.

Thanks to such connections, the agent is capable of learning movements indicated by equivalence messages and independence messages.

According to the first modification, the generation device 100 is capable of generating a graph for making the agent learn movements indicated by equivalence messages and independence messages.

### Second Modification of Embodiment

It is also possible for the generation device 100 to execute the following process. The process will be described below by using a concrete example.

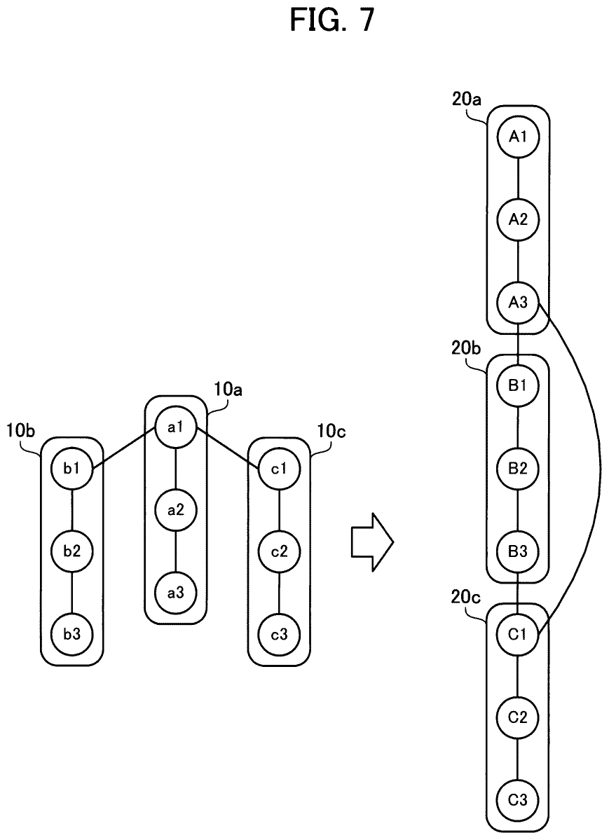

FIG. 7 is a diagram showing a concrete example of the graph generation process in a second modification. The modification unit 130 identifies the plurality of component groups arranged in parallel based on the hardware configuration information. For example, the modification unit 130 identifies the component groups 10a, 10b and 10c arranged in parallel based on the hardware configuration information.

The modification unit 130 modifies the plurality of identified component groups to a series arrangement. For example, the modification unit 130 modifies the component groups 10a, 10b and 10c to a series arrangement. The modification unit 130 modifies the hardware configuration information so that a first component belonging to a first component group among the plurality of identified component groups and a second component belonging to a second component group among the plurality of component groups are electrically connected to each other. For example, the modification unit 130 modifies the hardware configuration information so that the component a3 belonging to the component group 10a and the component c1 belonging to the component group 10c are electrically connected to each other.

The generation unit 140 generates a graph based on the modified hardware configuration information. Specifically, the generation unit 140 generates a graph in which a plurality of node groups corresponding to the plurality of component groups are connected in series. Further, the generation unit 140 generates a graph in which a first node corresponding to the first component belonging to the first component group among the plurality of component groups and a second node corresponding to the second component belonging to the second component group among the plurality of component groups are connected to each other via an edge. For example, the generation unit 140 generates a graph in which the node groups 20a, 20b and 20c corresponding to the component groups 10a, 10b and 10c are connected in series. The generation unit 140 generates a graph in which the node A3 corresponding to the component a3 belonging to the component group 10a and the node C1 corresponding to the component c1 belonging to the component group 10c are connected to each other via an edge.

Thanks to such connections, the agent is capable of learning movements indicated by independence messages and cooperation messages.

According to the second modification, the generation device 100 is capable of generating a graph for making the agent learn movements indicated by independence messages and cooperation messages.

### Third Modification of Embodiment

It is also possible for the generation device 100 to execute the following process. The process will be described below by using a concrete example.

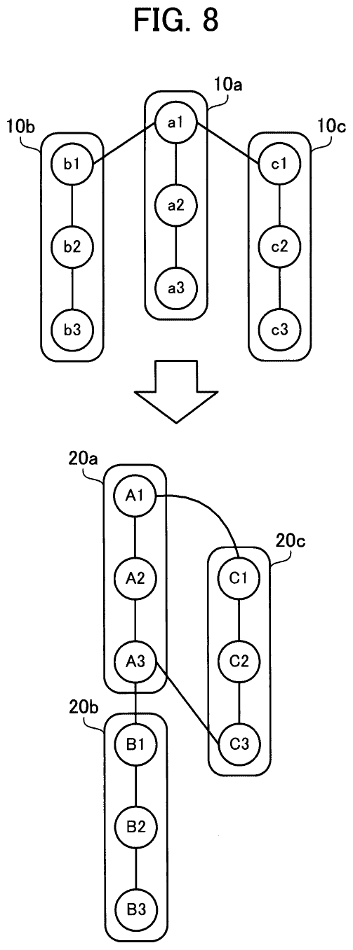

FIG. 8 is a diagram showing a concrete example of the graph generation process in a third modification. The modification unit 130 identifies the plurality of component groups arranged in parallel based on the hardware configuration information. For example, the modification unit 130 identifies the component groups 10a, 10b and 10c arranged in parallel based on the hardware configuration information.

The modification unit 130 modifies two or more component groups among the plurality of identified component groups to a series arrangement. For example, the modification unit 130 modifies the component groups 10a and 10b among the component groups 10a, 10b and 10c to a series arrangement. The modification unit 130 modifies the hardware configuration information so that a first component belonging to a first component group among the two or more component groups modified to a series arrangement and a second component belonging to a component group not modified are electrically connected to each other. For example, the modification unit 130 modifies the hardware configuration information so that the component a3 belonging to the component group 10a among the component groups 10a and 10b and the component c3 belonging to the component group 10c are electrically connected to each other.

The generation unit 140 generates a graph based on the modified hardware configuration information. Specifically, the generation unit 140 generates a graph in which two or more node groups corresponding to the two or more component groups among the plurality of component groups are connected in series. For example, the generation unit 140 generates a graph in which the node groups 20a and 20b corresponding to the component groups 10a and 10b are connected in series. Further, the remaining component group (e.g., the component group 10c) among the plurality of component groups has not been modified by the modification unit 130. Therefore, the node groups 20a and 20b and the node group 20c are connected in parallel, for example. Furthermore, the generation unit 140 generates a graph in which a node belonging to a first node group among the two or more node groups connected in series and a node belonging to a second node group connected in parallel with the two or more node groups are connected to each other via an edge. For example, the generation unit 140 generates a graph in which the node A3 belonging to the node group 20a among the node groups 20a and 20b and the node C3 belonging to the node group 20c connected in parallel with the node groups 20a and 20b are connected to each other via an edge.

Thanks to such connections, the agent is capable of learning movements indicated by equivalence messages, independence messages and cooperation messages.

According to the third modification, the generation device 100 is capable of generating a graph for making the agent learn movements indicated by equivalence messages, independence messages and cooperation messages.

The above description has been given of cases where the process is executed in the following order. The acquisition unit 120 acquires the hardware configuration information. The modification unit 130 identifies the plurality of component groups arranged in parallel based on the hardware configuration information. The modification unit 130 modifies the hardware configuration information. The generation unit 140 generates a graph based on the modified hardware configuration information.

It is also possible for the generation device 100 to generate the graph in the following order. The acquisition unit 120 acquires the hardware configuration information. The generation unit 140 generates a graph based on the hardware configuration information. The modification unit 130 identifies a plurality of node groups corresponding to the plurality of component groups arranged in parallel based on the graph. The modification unit 130 modifies the plurality of node groups. By this process, the generation device 100 is capable of generating the graphs described in the embodiment and the first to third modifications.

Further, it is also possible for the generation device 100 to generate the graph in the following order. The acquisition unit 120 acquires a graph including a plurality of node groups corresponding to the plurality of component groups arranged in parallel from the storage unit 110 or the external device. The modification unit 130 identifies the plurality of node groups corresponding to the plurality of component groups arranged in parallel based on the graph.

The modification unit 130 modifies the plurality of node groups. By this process, the generation device 100 is capable of generating the graphs described in the embodiment and the first to third modifications.

### DESCRIPTION OF REFERENCE CHARACTERS

10a, 10b, 10c: component group, 100: generation device, 101: processor, 102: volatile storage device, 103: nonvolatile storage device, 110: storage unit, 120: acquisition unit, 130: modification unit, 140: generation unit

What is claimed is:

1. A generation device comprising generating circuitry to generate a graph in which a plurality of node groups corresponding to a plurality of component groups arranged in parallel are connected in series or a graph in which a first node corresponding to a first component belonging to a first component group among the plurality of component groups and a second node corresponding to a second component belonging to a second component group among the plurality of component groups are connected to each other via an edge.

2. The generation device according to claim 1, wherein
the generating circuitry generates a graph in which two or more node groups corresponding to two or more component groups among the plurality of component groups are connected in series, and
the two or more node groups and a node group corresponding to a remaining component group among the plurality of component groups are connected in parallel.

3. The generation device according to claim 1, wherein the generating circuitry generates a graph in which the plurality of node groups corresponding to the plurality of component groups are connected in series and the first node and the second node are connected to each other via an edge.

4. The generation device according to claim 1, wherein the generating circuitry generates a graph in which two or more node groups corresponding to two or more component groups among the plurality of component groups are connected in series and a node belonging to a first node group among the two or more node groups and a node belonging to a second node group connected in parallel with the two or more node groups are connected to each other via an edge.

5. A generation method performed by a generation device, the generation method comprising:
generating a graph in which a plurality of node groups corresponding to a plurality of component groups arranged in parallel are connected in series or a graph in which a first node corresponding to a first component belonging to a first component group among the plurality of component groups and a second node corresponding to a second component belonging to a second component group among the plurality of component groups are connected to each other via an edge.

6. A generation device comprising:
a processor to execute a program; and
a memory to store the program which, when executed by the processor, performs a process of generating a graph in which a plurality of node groups corresponding to a plurality of component groups arranged in parallel are connected in series or a graph in which a first node corresponding to a first component belonging to a first component group among the plurality of component groups and a second node corresponding to a second component belonging to a second component group among the plurality of component groups are connected to each other via an edge.
